(19) United States
(12) Patent Application Publication
(10) Pub. No.: US 2026/0307496 A1
(43) Pub. Date: Oct. 8, 2026

(54) Method for Operating a High Voltage System of a Mobile Work Machine

(71) Applicant: Robert Bosch GmbH, Stuttgart (DE)

(72) Inventors: Dominik Thomas Hoffmann, Urmitz (DE); Lothar Jahn, Ulm (DE); Matthias Jerg, Neu-Ulm (DE)

(21) Appl. No.: 19/639,536

(22) Filed: Apr. 6, 2026

(30) Foreign Application Priority Data
Apr. 8, 2025 (DE) 10 2025 113 672.6

(51) Int. Cl. B60L 3/04; B60R 16/023; H02J 1/08; H02J 1/15

(52) U.S. Cl. CPC B60L 3/04; B60R 16/0231; H02J 1/084; H02J 1/15; B60L 2200/40; B60L 2240/547

(57) ABSTRACT

A method for operating a high voltage system of a mobile work machine is disclosed. The high voltage system includes an intermediate circuit and at least two high voltage components connected to the intermediate circuit, configured for energy exchange with the intermediate circuit. The high voltage system further includes a control system, configured to control the high voltage components. The control system includes at least two network connected electronic devices, configured to communicate by way of electronic messages. The method includes a) detecting an electronic communication fault between the electronic devices of the control system that impairs control of the high voltage system, and b) deactivating the high voltage components or decoupling the high voltage components from the intermediate circuit, so that the power flows between the high voltage components and the intermediate circuit are minimized, when in step a) a fault was detected that impairs the control of the high voltage system, wherein deactivating or decoupling the high voltage components occurs at least partially sequentially in an order by the control system taking into account at least one time interval.

This application claims priority under 35 U.S.C. § 119 to application no. DE 10 2025 113 672.6, filed on Apr. 8, 2025 in Germany, the disclosure of which is incorporated herein by reference in its entirety.

The present disclosure relates to a method for operating a high voltage system of a mobile work machine and a corresponding work machine.

### BACKGROUND

The present disclosure relates to a method for deactivating a high voltage system in a mobile work machine. High voltage systems are found in a variety of mobile work machines, for example, wheel loaders and excavators, particularly when an electric traction drive is employed in the mobile work machine. Deactivation of the high voltage system is relevant in two main applications: on the one hand, a normal deactivation when the mobile work machine stops at the end of work and on the other hand, a forced deactivation during operation when there is a relevant fault.

Specific requirements for a method for deactivation are derived from these use cases. In particular, these requirements include a coordinated deactivation of all high voltage components in order to avoid damage due to inadmissibly high currents or voltages and to minimize wear. In addition, rapid deactivation in response to failure conditions is important, although undesirable wear of the high voltage system may occur. Finally, the method is intended to be adaptable to different architectures of high voltage systems of different mobile work machines.

The prior art currently does not offer a solution that satisfies all of the stated requirements. Known methods often show weaknesses with respect to coordinating the shutdown of the individual high voltage components, avoiding inadmissibly high currents and voltages, or adaptability to different configurations of mobile work machines. There is therefore a need for a method that enables safe, fast, and low-wear deactivation of a high voltage system regardless of the particular type of machine. The disclosure addresses this gap in the prior art and offers a novel method with improved properties, which is particularly directed towards deactivating a high voltage system in response to failure conditions.

### SUMMARY

According to one embodiment of the present disclosure, there is provided a method for operating a high voltage system of a mobile work machine, wherein the high voltage system comprises an intermediate circuit and at least two high voltage components connected to the intermediate circuit, configured for energy exchange with the intermediate circuit, wherein the high voltage system further comprises a control system, configured to control said high voltage components, wherein the control system comprises at least two network connected electronic devices, configured to communicate by way of electronic messages, characterized in that the method comprises the following steps:
a) detecting interference in electronic communication between the electronic devices of the control system, for example, between two control units that impair the control of the high voltage system;
b) deactivating the high voltage components or decoupling the high voltage components from the intermediate circuit, so that power flows between the high voltage components and the intermediate circuit are minimized, when in step a) a fault was detected that interferes with controlling the high voltage system, wherein deactivating or decoupling of the high voltage components occurs at least partially sequentially in a predetermined order by the control system taking into account at least one time interval, in order to minimize damage and wear to the high voltage components.

“High voltage” is a term used in vehicle technology to refer to DC voltages over 60 Volts and AC voltages over 30 Volts. The high voltage system according to the disclosure is preferably operated at a voltage of at least 400 Volts, more preferably at least 800 Volts. The high voltage system according to the disclosure can thus enable a particularly efficient supply of power to the high voltage components via the intermediate circuit.

The at least partially sequential deactivation of high voltage components in a predetermined order according to the disclosure is advantageous, because in this way the best possible functionality of the mobile work machine during the deactivation of the high voltage system is enabled. This is particularly important when deactivation is triggered by detection of a communication fault while the mobile work machine is moving. For example, in such a situation, the method according to the present disclosure allows a steering device of the mobile work machine to remain as functional as possible during deactivation so that the driver of the mobile work machine is enabled to avoid dangerous situations during deactivation. In addition, the at least partially sequential deactivation of high voltage components in a predetermined order enables deactivation as low-wear as possible, for example by ensuring that a cooling device remains functional as long as possible. It may be provided in step b) that deactivating a high voltage component comprises placing it in a standby mode or readiness mode.

The consideration of at least one time interval in step b) is advantageous, since in this way it is possible to comply with a predetermined order when deactivating the high voltage components, even though the electronic communication in the control system is disrupted.

According to a preferred embodiment of the present disclosure, in step b) a function of the control system is carried out, which, depending on a high voltage component to be deactivated, provides at least one time interval related thereto, which indicates after what time period the deactivation of the high voltage component is to be initiated at the earliest and/or after what time period the deactivation of the high voltage component is to be completed at the latest. Preferably, such a function is provided for all electronic devices of the high voltage system, preferably locally on the electronic devices themselves. Thus, by taking into account coordinated time intervals when performing the method, a predetermined order of deactivation of the high voltage components in step b) can be reliably complied with even if there is extensive disruption to communication in the control system.

According to a preferred embodiment of the present disclosure, in step b) at least one time interval depends on between which electronic devices in step a) a fault with the electronic communication has been detected. Such dependence is advantageous because it allows a method that is tailored to the fault so that step b) can be carried out as quickly as possible.

It is advantageous if, in step b) at least one time interval represents an upper limit for a time period during which a high voltage component may remain operational before deactivation of the high voltage component or decoupling the high voltage component from the intermediate circuit occurs. In this way, it may be set a priori in the control system when a high voltage component is deactivated to enable a predictable and reproducible method.

Preferably, one of the high voltage components represents a voltage source for the intermediate circuit configured as a battery or as a power converter. This is advantageous because the high voltage system is thus powered in a proven manner. The power converter may be a DC-DC converter that converts the DC voltage of a power source, for example, a battery, into the DC voltage of the intermediate circuit. The power converter may be a bidirectional AC/DC converter, a rectifier, or an inverter disposed between a generator connected to an internal combustion engine and the intermediate circuit.

According to a preferred embodiment of the present disclosure, in step b) decoupling one of the high voltage components from the intermediate circuit comprises opening a contactor. This is advantageous because contactors are proven devices for electrically decoupling high voltage components from an intermediate circuit.

According to a preferred embodiment of the present disclosure, in step b) a voltage source is decoupled from the intermediate link by opening a contactor when a predetermined time interval has elapsed since the detection of a fault in step a) that impairs the control of the high voltage system, such that the voltage source is only decoupled from the intermediate link when, in step b), the power flows of all other high voltage components to the intermediate link have been minimized. Such a procedure is advantageous because the occurrence of impermissibly high voltages or currents when opening the contactors can be avoided so that wear on the high voltage system is minimized.

According to a preferred embodiment of the present disclosure, at least one of the high voltage components and one of the electronic devices of the control system is jointly embodied as a unit. Such design is advantageous as it allows for a modular construction of the high voltage system.

It is also advantageous if the method comprises the following additional step: Actively discharging the intermediate circuit and associated high voltage components so that a voltage of the intermediate circuit is set to a value below a voltage limit, preferably the voltage limit being within a range of 50 Volts to 70 Volts, and particularly preferably 60 Volts. Active discharging of the high voltage components may occur via discharging resistors. The mentioned voltage limits are advantageous because by lowering the voltage to a value below a voltage limit, hazards to persons due to electric shocks are limited.

According to a preferred embodiment of the present disclosure, a control system comprising at least two network connected electronic devices configured to perform a method according to the disclosure is provided.

According to a preferred embodiment of the present disclosure, a mobile work machine comprising a high voltage system is provided, the high voltage system comprising a control system according to the present disclosure, an intermediate circuit, and at least two high voltage components connected to the intermediate circuit configured for energy exchange with the intermediate circuit.

According to a preferred embodiment of the present disclosure, a computer program product comprising instructions that cause a control system according to the disclosure is provided to perform a method according to the disclosure when the instructions are executed by the control system according to the disclosure.

### BRIEF DESCRIPTION OF THE DRAWINGS

The present disclosure is described with reference to the accompanying figures, wherein the same reference numbers refer to the same parts and/or similar parts and/or corresponding parts of the system. Regarding the figures:

FIG. 1 schematically describes the structure of a high voltage system of a mobile work machine for an exemplary embodiment of the disclosure.

FIG. 2 schematically describes for two exemplary embodiments of a method according to the disclosure the sequence of deactivation of the high voltage system of a mobile work machine.

### DETAILED DESCRIPTION

In the following, the present disclosure is described with reference to certain embodiments as shown in the accompanying figures. Nonetheless, the present disclosure is not limited to the particular embodiments described in the following detailed description and shown in the figures, but the described embodiments merely illustrate some aspects of the present disclosure, the scope of which is defined by the claims.

Further changes and variations of the present disclosure are clear to those skilled in the art. The present description thus encompasses any amendments and/or variations of the present disclosure, the scope of which is defined by the claims.

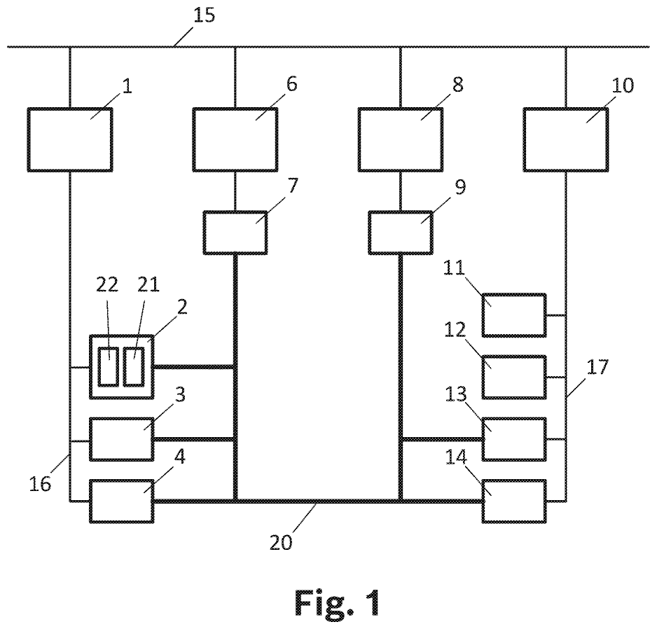

FIG. 1 schematically describes the structure of a high voltage system of a mobile work machine for an exemplary embodiment of the disclosure.

A high voltage control unit 1 is network connected to a traction drive control unit 6, a work device control unit 8, and a work machine control unit 10 via a first CAN bus 15. The mentioned control units are configured to exchange electronic messages via the first CAN bus 15, particularly those relating to control of the high voltage system. In addition, an input device (not shown) of the mobile work machine is connected to the first CAN bus 15.

The high voltage control unit 1 is network connected to a high voltage battery 2, a battery charger 3 and a DC voltage converter 4 via a second CAN bus 16. The high volt age control unit 1 is configured to control said high voltage components connected to it via the second CAN bus 16 by way of electronic messages.

The high voltage battery 2 includes battery contactors 21 and a battery management system 22 for controlling the high voltage battery 2. The battery management system 22 is configured to set the battery contactors 2 to either an open state or a closed state. If the battery contactors 21 are in a closed state, the high voltage battery 2 provides the intermediate circuit 20 with a high voltage, in this embodiment a DC voltage of 800 volts. An open state of the battery contactors 21 corresponds to a decoupling of the high voltage battery 2 from the intermediate circuit 20, because the high voltage battery 2 does not provide a high voltage to the intermediate circuit 20 in this case.

In this embodiment, the battery charger 3 is configured as an on-board charger that allows the high voltage battery 2 to be charged with power from the AC mains.

The DC converter 4 is configured to convert the high voltage of the intermediate circuit 20 to a lower voltage for the low voltage on-board network (not shown) of the mobile work machine, which may be, for example, 12 Volts. Further components of the mobile work machine can be powered via the low voltage on-board power system, for example the display unit 11, the already mentioned control units, and coolant pumps of cooling devices (not shown).

The traction drive control unit 6 is connected to a traction drive 7 and is configured to control that traction drive 7. The traction drive 7 includes a first inverter and a first electric motor associated therewith, mechanically coupled to one or more wheels of the mobile work machine. The traction drive 7 is powered by the intermediate circuit 20.

The work device control unit 8 is connected to a work device control drive 9 and is configured to control that work device drive 9. The work device drive 9 includes a second inverter, a second electric motor, and a hydropump configured to provide a working pressure mechanism to hydraulic cylinders of a work device. The hydropump may be designed as a constant or adjustable displacement volume hydropump. The work device drive 9 is powered by the intermediate circuit 20.

The work machine control unit 10 is network connected to a display unit 11, a thermal management control unit 12, a high voltage heater 13, and a high voltage compressor 14 via a third CAN bus 17. The work machine control unit 10 is configured as a so-called vehicle control unit (VCU) that plays a central role in controlling the mobile work machine. The thermal management control unit 12 is configured to control the high voltage heater 13 and the high voltage compressor 14. The high voltage heater 13 and the high voltage compressor 14 are powered via the intermediate circuit 20.

In this embodiment, all high voltage components, namely high voltage battery 2, battery charger 3, DC voltage converter 4, traction drive 7, work device drive 9, high voltage heater 13 and high voltage compressor 14 are each arranged as a unit with an electronic device, which in particular comprises a CAN transceiver and allows communication via electronic messages, in particular for controlling the high voltage component.

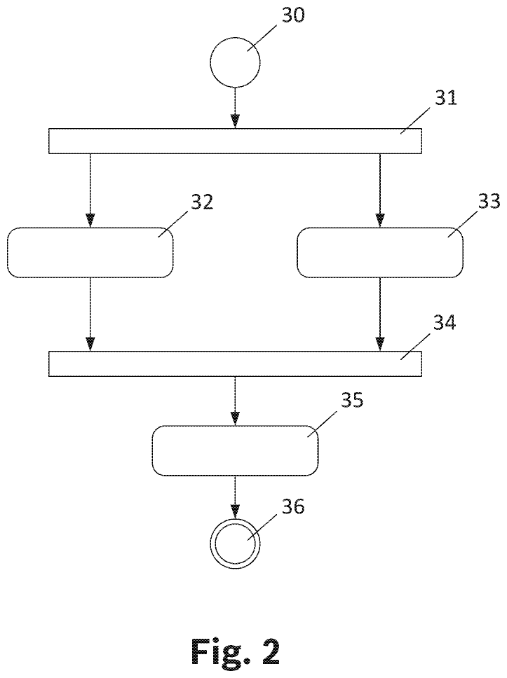

FIG. 2 schematically describes for two exemplary embodiments of a method according to the disclosure the sequence of deactivation of the high voltage system of a mobile work machine.

First, the first exemplary embodiment is described. The start node 30 represents the start of the method for deactivating the high voltage system, triggered in this first embodiment by detecting a fault in electronic communication between the high voltage control unit 1 and the high voltage battery 2. This communication fault is detected in both the high voltage control unit 1 and the battery management system 22 of the high voltage battery 2.

The branching node 31 indicates that actions are performed in parallel in the high voltage battery 2 and the high voltage control unit 1 in response to this fault.

As communication with the high voltage battery 2 is disrupted, it can no longer be reliably controlled by the high voltage control unit 1. It is provided, in particular for safety reasons, that the high voltage battery 2 reacts to such a fault with a decoupling from the intermediate circuit 20. However, a low-wear decoupling of the high voltage battery 2 from the intermediate circuit 20 requires that the power flow between the high voltage battery 2 and intermediate circuit 20 has been minimized beforehand. Otherwise, impermissibly high voltages or currents may occur that cause increased wear. The decoupling of the high voltage battery 2 from the intermediate circuit 20 is therefore not initiated until a first time interval has elapsed since the detection of the fault so that the other high voltage components can be deactivated prior to decoupling, as will be described further below. In this way, it can be ensured that the power flow between high voltage battery 2 and intermediate circuit 20 is minimal when the decoupling takes place.

The first action 32 represents a wait for the first time interval in the battery management system 22 after detecting the communication fault.

The second action 33 represents a deactivation of the other high voltage components by the high voltage control unit 1 (battery charger 3, DC converter 4, traction drive 7, work device drive 9, high voltage heater 13, and high voltage compressor 14). It is provided that this deactivation will be completed before the first time interval has elapsed, as already mentioned above. For this purpose, the duration of the first time interval can be determined by the high voltage control unit 1; for example, this duration can be in the form of pre-saved data in the high voltage control unit 1.

Deactivation of the high voltage components is triggered by the high voltage control unit 1 by communicating corresponding control commands to the high voltage components or to involved control units. It may be provided that such a control command for deactivating can have two characteristics. A first characteristic may request normal deactivation of a high voltage component corresponding to a preferred, low-wear shutdown operation where a time delay until completion of deactivation is permitted. A second characteristic may cause immediate deactivation of a high voltage component.

In the course of deactivating the high voltage components, a warning directed to the driver of the mobile work machine is also transmitted by the high voltage control unit 1 via the work machine control unit 10 to the display unit 11 so that the driver can prepare for the high voltage system to be deactivated.

Preferably, control commands of the first characteristic are first transmitted from the high voltage control unit 1 to the high voltage components that request normal deactivation. In that case, it is provided that a high voltage component will send feedback to the high voltage control unit 1 when deactivation is complete. For example, deactivation of the traction drive 7 from the traction drive control unit 6 via the first CAN bus 15 may be reported back to the high voltage control unit 1. Likewise, for example, deactivation of the high voltage heater 13 may be reported back to the high voltage control unit 1 by the work machine control unit 10. The reporting of the deactivation of battery charger 3 and DC voltage converter 4 to the high voltage control unit 1 can occur via the second CAN bus 16.

If the high voltage components mentioned above have not yet been deactivated after a second time interval has elapsed, the high voltage control unit 1 preferably forces an immediate deactivation of the high voltage components not yet deactivated with control commands of the second characteristic. As the duration of the first time interval is determinable from the high voltage control unit 1, the second time interval may be set to be of shorter duration than the first time interval. For example, the duration of the second time interval may be 100 milliseconds less than the duration of the first time interval. The second time interval thus represents an upper limit for a time period during which the high voltage components may remain operational after detection of the fault before deactivation is forced by the high voltage control unit 1. This ensures that the high voltage components are deactivated once the first time interval has elapsed.

It may be provided that the high voltage control unit 1 withdraws an enable of an active state from a deactivated high voltage component after receiving feedback about the deactivation. In this way, for example, reactivating the deactivated high voltage component may be prevented.

Preferably, when deactivating the high voltage components described above by the high voltage control unit 1, a predetermined order is considered so that functional dependencies between the high voltage components or dependencies between functions of the mobile work machine can be considered.

In this embodiment, the steering of the mobile work machine is coupled to the work device drive 9 such that normal steering requires operation of the work device drive 9. As long as the traction drive 7 of the mobile work machine is active, normal steering is to be available for safety reasons. It may be provided that this fact is taken into account in the order in which the high voltage components are deactivated. Preferably, the high voltage control unit 1 does not request deactivation of the work device drive 9 until a deactivation of the traction drive 7 by the traction drive control unit 6 has been reported.

In this exemplary embodiment, it is also provided that the DC voltage transformer 4 is deactivated at a time as late as possible, since the DC voltage transformer 4 ensures that the low voltage on-board power system is sufficiently powered. The low voltage on-board power system supplies power to control units and cooling devices that serve to cool the traction drive 7, work device drive 9, and high voltage battery 2. Premature deactivation of this cooling would interfere with the operation of said high voltage components and could result in damage to the high voltage components. Therefore, the DC voltage converter 4 is preferably only deactivated when the deactivation of the battery charger 3, traction drive 7, high voltage heater 13, and high voltage compressor 14 has been reported back to the high voltage control unit 1 by the work device control unit 8, in addition to deactivation of the work device drive 9.

The connection node 34 indicates that the parallel execution of actions is complete.

The third action 35, representing a decoupling of the high voltage battery 1 from the intermediate circuit 20, is performed after both the first action 32 and the second action 33 are completed. This decoupling is effected by the battery management system 22 opening the battery contactors 21. As the second action 33 has previously minimized the power flows between the high voltage consumers and the intermediate circuit 20, as described above, it is ensured that the power flow between the high voltage battery 2 and the intermediate circuit 20 has also been minimized. The electrical current flowing via the battery contactors 21 is therefore minimal, so that the opening of the battery contactors 21 is low-wear without impermissibly high voltages or currents occurring.

Preferably, the third action 35 additionally comprises actively discharging the intermediate circuit 20 and the high voltage components associated therewith. Active discharging may be triggered by corresponding control commands of the high voltage control unit 1 to the high voltage components battery charger 3, DC voltage converter 4, traction drive 7, work device drive 9, high voltage heater 13, and high voltage compressor 14 transmitted via one or more CAN buses, as described above for other control commands. Active discharging of the high voltage components may occur via discharging resistors. Active discharging sets the voltage of the intermediate circuit 20 to a value below a voltage limit, preferably below 60 Volts.

Subsequently, the end node 36 is reached, which represents the conclusion of the method according to the disclosure.

As already mentioned above, FIG. 2 schematically describes two different exemplary embodiments of a method according to the disclosure. In the following, the second exemplary embodiment is explained with reference to FIG. 2.

The start node 30 represents the start of the method for deactivating the high voltage system, triggered in this second embodiment by detecting a fault in electronic communication between the high voltage control unit 1 and the work device control unit 10. This communication fault is detected in both the high voltage control unit 1 and the work machine control unit 10. Since a sensible operation of the mobile work machine is no longer possible with such a fault, a deactivation of the high voltage system is subsequently provided.

The branching node 31 indicates that, in response to this fault, actions are initiated in parallel in the high voltage control unit 1 and in the work machine control unit 10. These actions are coordinated as explained below.

The first action 32 includes deactivation of high voltage components by the high voltage control unit 1 not affected by communication disruption (battery charger 3, DC voltage converter 4, ground drive 7, implement drive 9). The deactivations can first be requested via control instructions of a first characteristic, and in a second step, via control instructions of a second characteristic, as already described above. The high voltage battery 2 remains coupled to the intermediate circuit 20.

The second action 33 includes deactivation of high volt components by the work machine control unit 10, which can be deactivated therefrom (high voltage heaters 13 and high voltage compressor 14). In addition, as part of the second action 33, the work machine control unit 10 transmits a warning to the driver of the mobile work machine to the display unit 11 so that the driver can prepare for the high voltage system to be deactivated.

The third action 35, which represents a decoupling of the high voltage battery 2 from the intermediate circuit 20, is also triggered in this exemplary embodiment by the high voltage control unit 1. For this purpose, it is provided that the high voltage control unit 1 transmits a corresponding control command to the high voltage battery 2. This decoupling of the high voltage battery 2 from the intermediate circuit 20 is not further carried out because it has already been explained in the first design example. It should be noted that the third action 35 may additionally comprise active discharging of the intermediate circuit and associated high voltage components, see first exemplary embodiment. The connection node 34 indicates that the third action 35 is to be performed only when the first action 32 and the second action 33 are already complete. Thus, it is ensured that the decoupling of the high voltage battery 2 is low-wear as already described above. Since both the first action 32 and the third action 35 are controlled by the high voltage control unit 1, it is readily possible to perform these actions one after the other.

Coordinating the third action 35 with the second action 33, however, requires further action as communication between the high voltage control unit 1 and the work machine control unit 10 is disrupted.

Preferably, to coordinate the third action 35 with the second action 33, proceed as follows: The work machine control unit 10 ensures, by corresponding control commands to the involved high voltage components (high voltage heater 13 and high voltage compressor 14), that the second action 33 has been completed when a third time interval has elapsed since the communication fault has been detected. The duration of the third time interval can be determined by the work machine control unit 10. Preferably, this information is in the form of pre-saved data in a storage medium of the work machine control unit 10.

It is provided that the duration of the third time interval may also be determined in the high voltage control unit 1. Thus, it can be ensured that the third action 35 is not initiated until after the completion of the second action 32.

It is preferably provided that the high voltage control unit 1 uses a function to determine the duration of this time interval. Preferably, this function provides a duration of a time interval to be waited for, wherein the function may depend on which high voltage component is to be deactivated (in this case the high voltage battery 2), and on which electronic devices, control units, or high voltage components the communication is disrupted (in this case for the work machine control unit 10). Preferably, this function is based on data that is pre-stored in a storage medium of the high voltage control unit 1. However, it is also possible that the function mentioned is provided via an interface, for example via an internet connection. It may be provided that the high voltage control unit 1 may already use the stated function in the first action 32 in order to achieve a time sequence of deactivation of the high voltage components.

In a further development of the disclosure, the work machine control unit 10 also uses such a function to separately determine the respective waiting time intervals for deactivating the high voltage heater 13 and the high voltage compressor 14. In this way, despite the communication fault, it is possible to ensure that an order is followed when deactivating high voltage heater 13 and high voltage compressor 14.

After the execution of the third action 35, the end node 36 is reached, which represents the completion of the method according to the disclosure.

While the present disclosure has been described with reference to the embodiments described above, it is clear to those skilled in the art that it is possible to realize various modifications, variations and improvements of the present disclosure in light of the teaching described above and within the scope of the appended claims without departing from the scope of the disclosure.

Moreover, the areas where one skilled in the art is likely to be knowledgeable have not been described herein in order to avoid unnecessarily obscuring the disclosure described.

Accordingly, the disclosure is not intended to be limited by the specific illustrative embodiments, but only by the scope of the appended claims.

What is claimed is:

1. A method for operating a high voltage system of a mobile work machine, wherein the high voltage system includes an intermediate circuit and at least two high voltage components connected to the intermediate circuit, configured for energy exchange with the intermediate circuit, wherein the high voltage system further comprises a control system, configured to control the high voltage components, wherein the control system includes at least two network connected electronic devices, configured to communicate by way of electronic messages, the method comprising:
a) detecting an electronic communication fault between the electronic devices of the control system that impairs control of the high voltage system; and
b) deactivating the high voltage components or decoupling the high voltage components from the intermediate circuit, so that power flow between the high voltage components and the intermediate circuit are minimized, when in step a) a fault was detected that interferes with controlling the high voltage system, wherein deactivating or decoupling the high voltage components occurs at least partially sequentially in an order by the control system taking into account at least one time interval.

2. The method according to claim 1, wherein in step b) a function of the control system is performed, which provides at least one time interval depending on a high voltage component to be deactivated, which is considered in step b).

3. The method according to claim 1, wherein in step b) the at least one time interval depends on between which electronic devices in step a) an electronic communication fault has been detected.

4. The method according to claim 1, wherein in step b) the at least one time interval represents an upper limit for a time period during which a high voltage component may remain operational before deactivation of the voltage component or decoupling of the high voltage component from the intermediate circuit.

5. The method according to claim 1, wherein one of the high voltage components represents a voltage source for the intermediate circuit configured as a battery or as a power converter.

6. The method according to claim 1, wherein in step b) the decoupling of one of the high voltage components from the intermediate circuit includes opening a contactor.

7. The method according to claim 5, wherein, in step b) a voltage source is decoupled from the intermediate circuit by opening a contactor when a predetermined time interval has elapsed since the detection of a fault in step a) that impairs the control of the high voltage system, such that the voltage source is only decoupled from the intermediate circuit when, in step b), the power flows of all other high voltage components to the intermediate circuit have been minimized.

8. The method according to claim 1, wherein at least one of the high voltage components and one of the electronic devices of the control system are designed together as a unit.

9. The method according to claim 1, further comprising:
c) actively discharging the intermediate circuit and associated high voltage components so that a voltage of the intermediate circuit is set to a value below a voltage limit.

10. A control system comprising at least two network connected electronic devices configured to perform the method according to claim 1.

11. A mobile work machine comprising a high voltage system, the high voltage system comprising the control system according to claim 10, an intermediate circuit, and at least two high voltage components connected to the intermediate circuit configured to exchange power with the intermediate circuit.

12. A computer program product comprising instructions that cause a control system to perform the method according to claim 1 when the instructions are executed by the control system.
